(19) United States
(12) Patent Application Publication
(10) Pub. No.: US 2025/0309716 A1
(43) Pub. Date: Oct. 2, 2025

(54) STATOR HAVING A COOLING STRUCTURE AND A MOTOR INCLUDING THE STATOR

(71) Applicants: Hyundai Motor Company, Seoul (KR); Kia Corporation, Seoul (KR); CHUNG ANG University Industry Academic Cooperation Foundation, Seoul (KR)

(72) Inventors: Dong Hui Cheon, Seoul (KR); Su Hyeon Maeng, Seoul (KR); Chul Min Ahn, Anyang-si (KR); Baek Yu Kim, Hwaseong-si (KR); Tal Chol Kim, Bucheon-si (KR); Se Hyeon Cho, Cheonan-si (KR); Ju Ho Park, Gumi-si (KR); Eui Been Jung, Ansan-si (KR); Dae Young Kong, Incheon (KR); Hyoung Soon Lee, Seongnam-si (KR)

(21) Appl. No.: 18/947,162

(22) Filed: Nov. 14, 2024

(30) Foreign Application Priority Data
Mar. 29, 2024 (KR) 10-2024-0042912

(51) Int. Cl. H02K 3/24

(52) U.S. Cl. CPC H02K 3/24

(57) ABSTRACT

An embodiment stator includes a stator core including a plurality of teeth and a plurality of slots alternately arranged in a circumferential direction at an inner portion of the stator core, a stator coil wound around the teeth, and a plurality of cooling passages disposed in the stator core and arranged in the circumferential direction of the stator core, wherein each of the cooling passages is configured to allow a cooling fluid to flow therethrough, and wherein each of the cooling passages includes a plurality of radial passage portions disposed at the inner portion of the stator core, extending in a radial direction of the stator core, and arranged in an axial direction of the stator core, and a plurality of axial passage portions disposed at an outer portion of the stator core, connected to the radial passage portions, and extending in the axial direction of the stator core.

### CROSS-REFERENCE TO RELATED APPLICATIONS

This application claims the benefit of Korean Patent Application No. 10-2024-0042912, filed on Mar. 29, 2024, which application is hereby incorporated herein by reference.

### TECHNICAL FIELD

The present disclosure relates to a motor.

### BACKGROUND

As is known, eco-friendly vehicles, such as pure electric vehicles (EVs), hybrid electric vehicles (HEVs), and fuel cell electric vehicles (FCEVs) are all electric vehicles in a broad sense that travel using electric motors.

An eco-friendly vehicle drives and controls the motor by applying current supplied from a high-voltage power source to the motor, which is the driving source to drive the vehicle.

As such, the eco-friendly vehicle uses the motor to generate driving force for travelling, and the motor (i.e., driving motor) that drives the eco-friendly vehicle needs high efficiency and power density.

Generally, a stator core of the motor has a structure comprising a plurality of iron plates stacked on one another. The motor is driven by current supplied to a stator coil inserted into a slot in the stator core.

In recently developed eco-friendly vehicles, the efficiency of the motor is known to be about 90%, and heat loss accounts for a significant portion of the remaining loss. It is known that the main heat source in the motor is the stator coil.

Heat generated in the motor deteriorates motor performance, increases stress on the components that make up the motor, and causes changes in physical properties, thereby shortening the lifespan of the motor.

The above information disclosed in this background section is only for enhancement of understanding of the background of embodiments of the present disclosure, and therefore it may contain information that does not form the already known prior art.

### SUMMARY

The present disclosure relates to a motor. Particular embodiments relate to a stator having a cooling structure to improve motor cooling performance and a motor including the stator.

A motor of the prior art has a cooling passage through which a cooling fluid flows for cooling. The cooling passage is provided in a motor housing or in a stator core. The cooling fluid used to cool the motor flows through the cooling passage and absorbs heat generated from a stator coil to cool the motor.

Referring to FIG. 7, cooling passages 2 in a stator core 1 are provided at a radial outer portion of the stator core 1 and extend in an axial direction. The cooling passage 2 is configured to allow a cooling fluid to flow in one direction, and the cooling fluid indirectly cools a stator coil (not shown) disposed at a radial inner portion of the stator core 1.

However, the method of cooling a motor by using cooling passages causes a decrease in motor cooling efficiency and motor performance due to the distance between the cooling passage and the stator coil.

For this reason, embodiments of the present disclosure can solve problems associated with the prior art, and an embodiment of the present disclosure provides a stator having a new cooling structure capable of cooling a stator coil more effectively than the prior art.

The embodiments of the present disclosure are not limited to the foregoing, and other embodiments not mentioned herein will be clearly understood by those of ordinary skill in the art to which the present disclosure pertains based on the description below.

One embodiment of the present disclosure provides a stator including a stator core provided with teeth and slots being alternately arranged in a circumferential direction at an inner portion of the stator core, a stator coil wound around the teeth, and a plurality of cooling passages, through which a cooling fluid flows, provided in the stator core and arranged in the circumferential direction of the stator core. Here, each of the cooling passages may include a plurality of radial passage portions disposed at an inner portion of the stator core, extending in a radial direction of the stator core, and arranged in an axial direction of the stator core, and a plurality of axial passage portions disposed at an outer portion of the stator core, connected to the radial passage portions, and extending in the axial direction of the stator core.

In an embodiment, the radial passage portions may be adjacent to a first slot of the plurality of slots and surround the first slot. Moreover, the radial passage portions may be provided at teeth disposed at opposite sides of the first slot among the plurality of teeth.

In another embodiment, the radial passage portions may be connected to the axial passage portions via a plurality of bridge passage portions. Here, the bridge passage portions may extend in the radial direction of the stator core.

In still another embodiment, the cooling passage may allow fluid to flow in through first axial passage portions, each disposed at a corresponding one of axial opposite ends of the stator core, among the plurality of axial passage portions, and may discharge fluid through a first radial passage portion disposed at an axial center of the stator core among the plurality of radial passage portions.

In yet another embodiment, the first radial passage portion may be provided with a discharge passage portion configured to discharge fluid outside.

In another embodiment, the stator core may have axial opposite ends each provided with a cooling chamber in communication with the cooling passage, the stator coil may be provided with a pair of end coil portions protruding outwardly of the stator core in the axial direction, and the end coil portions may be submerged in the fluid filling the cooling chamber.

Another embodiment of the present disclosure provides a motor including the stator.

Other aspects and embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of embodiments of the present disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the embodiments of the present disclosure, and wherein:

FIG. 1 is a view partially illustrating the cross-sectional structure of a motor according to an embodiment of the present disclosure;

FIG. 2 is a view partially illustrating a stator according to an embodiment of the present disclosure;

FIG. 3 is a view taken along line A-A of FIG. 2;

FIG. 4 is a view partially illustrating the cross-sectional structure of the stator according to an embodiment of the present disclosure;

FIG. 5 is a view partially illustrating a stator according to an embodiment of the present disclosure;

FIG. 6 is a cross-sectional view partially illustrating the stator according to an embodiment of the present disclosure; and

FIG. 7 is a partial view illustrating cooling passages in a stator of the prior art.

It should be understood that the appended drawings are not necessarily to scale, presenting a somewhat simplified representation of various features illustrative of the basic principles of embodiments of the present disclosure. The specific design features of embodiments of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawings.

### DETAILED DESCRIPTION OF ILLUSTRATIVE EMBODIMENTS

Hereinafter, embodiments of the present disclosure will be described with reference to the accompanying drawings. The matters described in the attached drawings may be different from those actually implemented in order to facilitate description of the embodiments of the present disclosure.

In this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of exemplary embodiments of the present disclosure.

Moreover, in this specification, terms such as “radial direction,” “axial direction,” and “circumferential direction” are determined with respect to a “stator core” unless otherwise specified.

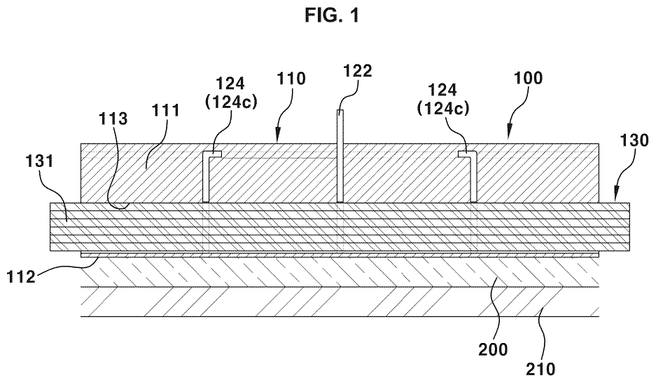

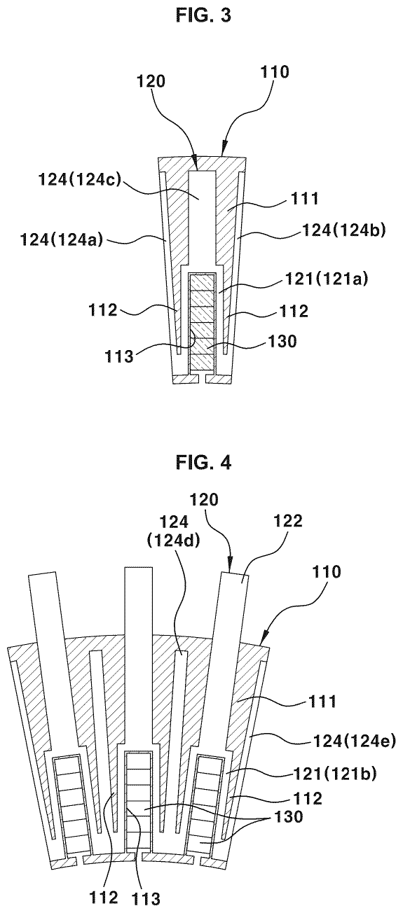

As illustrated in FIG. 1 to FIG. 3, a motor according to an embodiment of the present disclosure may include a stator 100, a rotor 200 disposed at a radial inner side of the stator 100, and a rotation shaft 210, which is the rotation center of the rotor 200. Moreover, although not specifically illustrated in the drawing, the rotor 200 may have the structure of a general motor rotor.

The stator 100 includes a stator core 110 including a plurality of iron plates stacked on one another and a stator coil 130 to which current for driving the motor is selectively applied.

The stator core 110 includes a core body 111 having a hollow cylindrical shape, teeth 112 protruding in the radial direction at the inner end of the core body 111, and a plurality of slots 113 provided between the teeth 112.

The core body 111 is a portion corresponding to the outer portion of the stator core 110, and the teeth 112 and the slots 113 are provided at the inner portion of the stator core 110. The teeth 112 and the slots 113 are alternately arranged in the circumferential direction at the inner end of the core body 111.

The stator coil 130 is wound around the teeth 112 and is inserted to be positioned in the slot 113 located at circumferential opposite sides of the tooth 112. Here, a portion of the stator coil 130 (i.e., an end coil portion) is located at the outer side of the slot 113 and protrudes in the axial opposite direction of the stator core 110. In other words, the stator coil 130 includes a pair of end coil portions 131 protruding outwardly of the axial opposite sides of the stator core 110.

In order to cool the stator 100 and the motor including the stator 100, the stator core 110 is provided with a plurality of cooling passages 120 arranged in the circumferential direction.

Each of the cooling passages 120 is configured to allow fluid for cooling the stator core 110, the stator coil 130, etc. (i.e., cooling fluid) to flow therethrough.

Moreover, the cooling passage 120 has a structure being adjacent to one slot (i.e., a first slot) among the plurality of the slots 113 provided in the stator core 110. The cooling passages 120 are individually adjacent to each of the slots 113, thereby increasing the cooling efficiency of the stator coil 130 inserted to be positioned in the slot 113.

Here, the first slot 113 is one of the slots 113 provided in the stator core 110. In other words, the first slot 113 means each of the slots adjacent to the cooling passages 120 provided in the stator core 110. Therefore, all of the slots 113 provided in the stator core 110 may be first slots. The stator core 110 may include a structure in which a first slot 113 and a cooling passage 120 adjacent to the first slot 113 are repeatedly arranged in the circumferential direction.

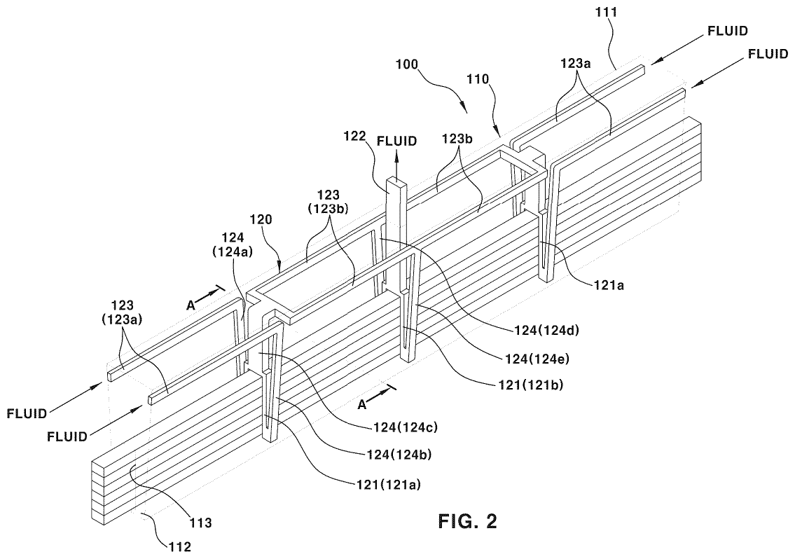

As illustrated in FIG. 2 to FIG. 4, the cooling passage 120 may include radial passage portions 121, axial passage portions 123, and bridge passage portions 124.

The radial passage portions 121 are arranged in the axial direction of the stator core 110 and are spaced apart from one another at a predetermined distance in the axial direction. More specifically, the radial passage portions 121 are spaced apart in the axial direction at a distance greater than or equal to the length of the axial passage portions 123.

The radial passage portions 121 each extend in the radial direction of the stator core 110 and neighbor the first slot 113. To this end, the radial passage portion 121 is provided between a pair of teeth 112 disposed adjacent to opposite sides of the first slot 113. The radial passage portion 121 may be disposed at the inner portion of the stator core 110 and extend to surround the first slot 113. For example, the radial passage portion 121 may be a rectangular structure with one side open. Moreover, the radial passage portion 121 may form a downstream end at the core body 111.

The radial passage portion 121 may be brought into fluid communication with the axial passage portions 123 via the bridge passage portions 124.

The axial passage portions 123 are disposed at the outer portion of the stator core 110 (i.e., the core body) and extend in the axial direction. With respect to the flow direction of the fluid, a pair of first axial passage portions 123a are connected to a first radial passage portion 121a via a first bridge passage portion 124a and a second bridge passage portion 124b. The first bridge passage portion 124a is connected to a first upstream end of the first radial passage portion 121a, and the second bridge passage portion 124b is connected to a second upstream end of the first radial passage portion 121a. The first and second upstream ends of the first radial passage portion 121a are named with respect to the flow direction of the fluid.

The first bridge passage portion 124a and the second bridge passage portion 124b extend in the radial direction of the stator core 110, and the upstream end of the first bridge passage portion 124a and the upstream end of the second bridge passage portion 124b are each directly connected to the downstream ends of the pair of first axial passage portions 123a.

The pair of first axial passage portions 123a are arranged to be spaced apart from each other in the circumferential direction of the stator core 110, and fluid flows in through their upstream ends. Moreover, with respect to the flow direction of the fluid and the first radial passage portion 121a, the pair of first axial passage portions 123a are upstream axial passage portions, and a pair of second axial passage portions 123b are downstream axial passage portions.

Here, the first radial passage portion 121a is not provided with a discharge passage portion 122, and a second radial passage portion 121b is provided with the discharge passage portion 122 for discharging fluid (see FIG. 2). With respect to the flow direction of the fluid, the second radial passage portion 121b is disposed behind the first radial passage portion 121a.

The pair of first axial passage portions 123a and the pair of second axial passage portions 123b are disposed at opposite sides of the first radial passage portion 121a with respect to the axial direction of the stator core 110 and are connected to the first radial passage portion 121a. Here, the second axial passage portions 123b are connected to the downstream end of the first radial passage portion 121a via a third bridge passage portion 124c. The third bridge passage portion 124c has an upstream end connected to the downstream end of the first radial passage portion 121a and has a downstream end connected to the upstream ends of the second axial passage portions 123b.

The second radial passage portion 121b is connected to the downstream ends of the second axial passage portions 123b. Here, the second radial passage portion 121b is connected to the pair of second axial passage portions 123b via a fourth bridge passage portion 124d and a fifth bridge passage portion 124e.

The discharge passage portion 122 is directly connected to the downstream end of the second radial passage portion 121b and extends in the radial direction of the stator core 110 to protrude out of the stator core 110.

Although not specifically illustrated in the drawing, the discharge passage portion 122 may extend to a motor housing (not shown), to which the stator core 110 is press-fitted, to discharge the fluid flowed in from the second radial passage portion 121b to the outside. The discharge passage portion 122 may discharge fluid to the outside through a separate cooling channel provided in the motor housing.

The second radial passage portion 121b provided with the discharge passage portion 122 is disposed at the axial center of the stator core 110 and may discharge the fluid flowed in through the upstream ends of the first axial passage portions 123a out of the motor through the discharge passage portion 122.

As illustrated in FIG. 2, the opposite side portions of the cooling passage 120 may be symmetrical with respect to the second radial passage portion 121b provided with the discharge passage portion 122. In other words, the radial passage portions 121, the axial passage portions 123, and the bridge passage portions 124 constituting the cooling passage 120 may be symmetrical with respect to the second radial passage portion 121b.

Accordingly, with respect to the axial direction of the stator core 110, the pair of first axial passage portions 123a and the pair of second axial passage portions 123b, the first to third bridge passage portions 124a, 124b, 124c, and the first radial passage portion 121a may all be provided at the opposite sides of the second radial passage portion 121b.

The cooling passage 120 allows fluid to flow in through the pair of first axial passage portions 123a each disposed at a corresponding one of the axial opposite ends of the stator core 110 and discharges the fluid through the second radial passage portion 121b disposed at the axial center of the stator core 110.

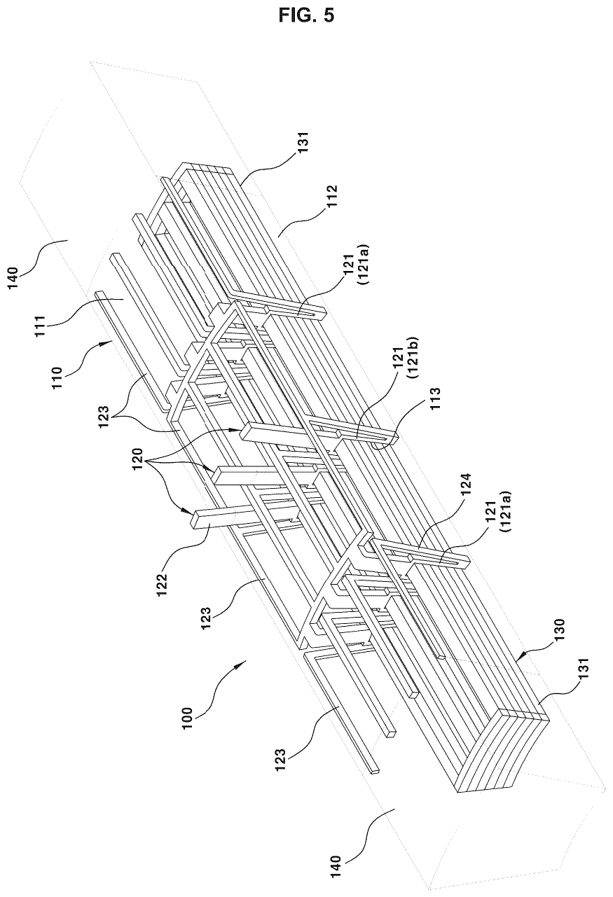

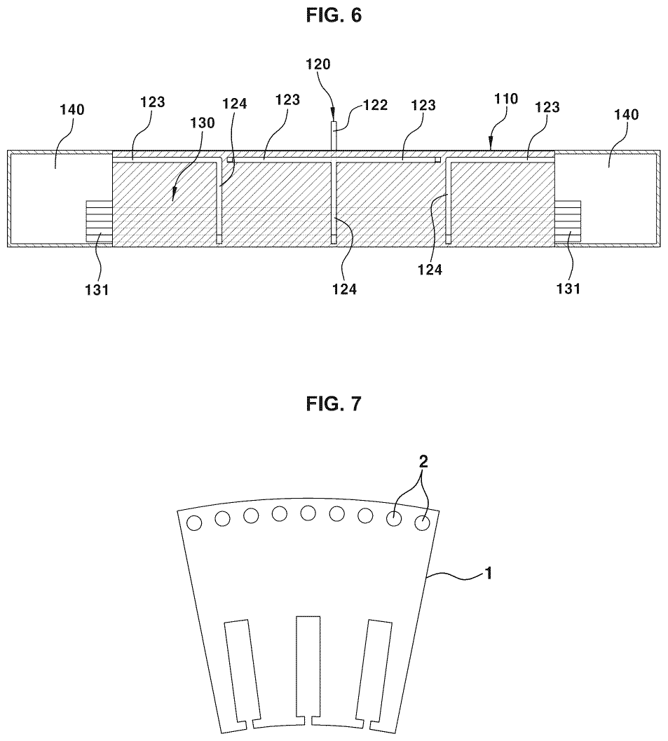

Meanwhile, as illustrated in FIG. 5 and FIG. 6, the stator core 110 may have axial opposite ends each provided with a cooling chamber 140 in communication with the cooling passages 120. The cooling chambers 140 each may be adjacent to a corresponding one of the axial opposite ends of the stator core 110 and may be brought into fluid communication with the pair of first axial passage portions 123a each disposed at a corresponding one of the axial opposite ends of the stator core 110.

The cooling chambers 140 are each filled with cooling fluid, and the end coil portions 131 of the stator coil 130 are each inserted into a corresponding one of the cooling chambers 140 and submerged in the cooling fluid. Accordingly, the end coil portions 131 are directly cooled, increasing the cooling efficiency of the motor.

Although not specifically illustrated in the drawing, the cooling chamber 140 is a sealed space that allows for the inflow and outflow of cooling fluid. The axial opposite ends of the stator core 110 each may have a structure having the cooling chamber 140, and the structure may be disposed inside a motor housing (not shown) with the stator core 110 built therein. The structure may be supported by being coupled to the stator core 110, or it may be supported by being coupled to the motor housing. Furthermore, the structure is sealed to prevent the fluid filling the cooling chamber 140 from leaking to the rotor 200 and the rotation shaft 210.

The stator 100 of embodiments of the present disclosure configured as above and the motor including the stator 100 may effectively cool the stator coil 130 while maintaining electromagnetic performance and mechanical performance, thereby minimizing loss due to heat generation in the stator coil 130 and improving motor performance.

As is apparent from the above description, embodiments of the present disclosure provide the following effects.

Embodiments of the present disclosure may cool the stator coil and the stator more effectively compared to the prior art by adopting a cooling passage including a radial passage portion and an axial passage portion, thereby increasing motor cooling efficiency.

Accordingly, embodiments of the present disclosure may minimize performance degradation due to heat generation in the stator coil and improve motor performance.

Effects of embodiments of the present disclosure are not limited to what has been described above, and other effects not mentioned herein will be clearly recognized by those skilled in the art based on the above description.

Terms or words used in this specification and claims described below should not be construed as being limited to conventional or dictionary meanings. In addition, the scope of the embodiments of the present disclosure is not limited to the above-described embodiments, and various modifications and improvements by those skilled in the art using the basic concept of the embodiments of the present disclosure as defined in the claims below will also be included in the scope of the embodiments of the present disclosure.

What is claimed is:

1. A stator comprising:
a stator core comprising a plurality of teeth and a plurality of slots alternately arranged in a circumferential direction at an inner portion of the stator core;
a stator coil wound around the teeth; and
a plurality of cooling passages disposed in the stator core and arranged in the circumferential direction of the stator core, wherein each of the cooling passages is configured to allow a cooling fluid to flow therethrough, and wherein each of the cooling passages comprises:
a plurality of radial passage portions disposed at the inner portion of the stator core, extending in a radial direction of the stator core, and arranged in an axial direction of the stator core; and
a plurality of axial passage portions disposed at an outer portion of the stator core, connected to the radial passage portions, and extending in the axial direction of the stator core.

2. The stator of claim 1, wherein the radial passage portions are adjacent to a first slot of the plurality of slots and surround the first slot.

3. The stator of claim 2, wherein the radial passage portions are disposed at first teeth disposed at opposite sides of the first slot among the plurality of teeth.

4. The stator of claim 1, wherein the radial passage portions are connected to the axial passage portions via a plurality of bridge passage portions.

5. The stator of claim 4, wherein the bridge passage portions extend in the radial direction of the stator core.

6. The stator of claim 1, wherein each of the cooling passages is configured to:
allow the cooling fluid to flow in through first axial passage portions, each disposed at axial opposite ends of the stator core, among the plurality of axial passage portions; and
discharge the cooling fluid through a first radial passage portion disposed at an axial center of the stator core among the plurality of radial passage portions.

7. The stator of claim 6, wherein the first radial passage portion comprises a discharge passage portion configured to discharge the cooling fluid outside.

8. The stator of claim 1, wherein the stator core has axial opposite ends each comprising a cooling chamber in communication with the cooling passages.

9. The stator of claim 8, wherein the stator coil comprises a pair of end coil portions protruding outwardly of the stator core in the axial direction, and wherein the end coil portions are configured to be submerged in the cooling fluid filling the cooling chambers.

10. A motor comprising:
a stator comprising:
a stator core comprising a plurality of teeth and a plurality of slots alternately arranged in a circumferential direction at an inner portion of the stator core;
a stator coil wound around the teeth; and
a plurality of cooling passages disposed in the stator core and arranged in the circumferential direction of the stator core, wherein each of the cooling passages is configured to allow a cooling fluid to flow therethrough, and wherein each of the cooling passages comprises:
a plurality of radial passage portions disposed at the inner portion of the stator core, extending in a radial direction of the stator core, and arranged in an axial direction of the stator core; and
a plurality of axial passage portions disposed at an outer portion of the stator core, connected to the radial passage portions, and extending in the axial direction of the stator core.

11. The motor of claim 10, wherein the radial passage portions are adjacent to a first slot of the plurality of slots and surround the first slot.

12. The motor of claim 11, wherein the radial passage portions are disposed at first teeth disposed at opposite sides of the first slot among the plurality of teeth.

13. The motor of claim 10, wherein the radial passage portions are connected to the axial passage portions via a plurality of bridge passage portions.

14. The motor of claim 13, wherein the bridge passage portions extend in the radial direction of the stator core.

15. The motor of claim 10, wherein each of the cooling passages is configured to:
allow the cooling fluid to flow in through first axial passage portions, each disposed at axial opposite ends of the stator core, among the plurality of axial passage portions; and
discharge the cooling fluid through a first radial passage portion disposed at an axial center of the stator core among the plurality of radial passage portions.

16. The motor of claim 15, wherein the first radial passage portion comprises a discharge passage portion configured to discharge the cooling fluid outside.

17. The motor of claim 10, wherein the stator core has axial opposite ends each comprising a cooling chamber in communication with the cooling passages.

18. The motor of claim 17, wherein the stator coil comprises a pair of end coil portions protruding outwardly of the stator core in the axial direction, and wherein the end coil portions are configured to be submerged in the cooling fluid filling the cooling chambers.
